(19) United States
(12) Patent Application Publication
(10) Pub. No.: US 2010/0066746 A1
(43) Pub. Date: Mar. 18, 2010

(54) Widgetized avatar and a method and system of creating and using same

(76) Inventor: Robb Fujioka, Manhattan Beach, CA (US)

Correspondence Address: Drinker Biddle & Reath LLP, One Logan Square, 18th and Cherry Streets, Philadelphia, PA, 19103-6996, US

(21) Appl. No.: 12/584,264

(22) Filed: Sep. 2, 2009

Related U.S. Application Data
(60) Provisional application No. 61/190,810, filed on Sep. 2, 2008.

(51) Int. Cl. G06T 15/70

(52) U.S. Cl. 345/473

(57) ABSTRACT

A widgetized avatar and a method and system of creating and using same is disclosed. The avatar includes computing code that provides for addition of the avatar as non-static content to at least two unique at least partially static web pages, and secondary computing code resident within the computing code, wherein the secondary computing code provides for association with at least one other portion of the computing code of ones selected from a plurality of physical characteristics, a plurality of personal information, and a plurality of actions.

### CROSS-REFERENCE TO RELATED APPLICATIONS

This application claims priority to U.S. Provisional Patent Application No. 61/190,810, entitled A WIDGETIZED AVATAR AND A METHOD AND SYSTEM OF CREATING AND USING SAME, filed on Sep. 2, 2008 and naming inventor Robb Fujioka, which application is hereby incorporated by reference herein as if set forth in the entirety.

### FIELD OF THE INVENTION

The present invention is directed to avatars for use in computing communities and, more particularly, to a widgetized avatar and a method and system of creating and using same.

### BACKGROUND OF THE INVENTION

Many computing and entertainment embodiments allow for a user, player, or viewer to create an “avatar.” An avatar is typically a virtual manifestation of that user's “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics of the avatar likely have only limited applicability to the physicality of the real-world user, due in part to the limited physical, clothing and the like options available in creating the avatar, and the typical information associated with the avatar, other than its physicality, is limited or nonexistent.

Additionally, present avatars need to be created over and over again, and are highly variable for the same real user as between different applications using an avatar, in principal part because avatars are not typically transferable as between multiple applications. Further, present avatars present little or no monetization or marketing opportunities, nor do present avatars allow for collection of, or provision to, potential transaction partners of the preferences, characteristics or interests of the actual user.

Thus, the need exists for an avatar, and an apparatus, system and method related thereto, that allows for transferability, improved physical relation to the actual user, more information regarding the actual user, and improved marketing, monetization and transaction opportunities related to the user's avatar.

### SUMMARY OF THE INVENTION

An avatar system and method of disclosed. The avatar includes computing code that provides for addition of the avatar as non-static content to at least two unique at least partially static web pages, and secondary computing code resident within the computing code, wherein the secondary computing code provides for association with at least one other portion of the computing code of: ones selected from a plurality of physical characteristics, a plurality of personal information, and a plurality of actions.

An avatar trading card system and method is also disclosed. This card includes a front of the avatar trading card including an avatar, a back of the avatar trading card including a selectable display for display of categorized information, wherein at least a portion of the categorized information is associated with one or more subjects of the avatar, and a toggle that provides for a toggle between the back and the front, wherein the selectable display provides selectability of categorized information.

A method of configuring an online persona is also disclosed. The method includes creating an avatar representative of a likeness of a computer user, and configuring the created avatar by: modifying a first set of visible attributes, and accepting a first set of identifying information that is linked to the first set of visible attributes, modifying a second set of visible attributes, and accepting a second set of identifying information that is linked to the second set of visible attributes, wherein the accepting of the first set of identifying information increases a number of available ones of the first set of visible attributes, and wherein accepting the second set of identifying information increases a number of available ones of the second set of visible attributes.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an avatar in accordance with the present invention; and

FIG. 2 illustrates an avatar in accordance with the present invention;

FIG. 3 illustrates an avatar in accordance with the present invention;

FIG. 4 illustrates a plurality of avatars in accordance with the present invention; and

FIG. 5 illustrates a flow diagram in accordance with the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical avatar and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An avatar is understood by one of ordinary skill in the art to include a computer user's representation of him or herself, or a single or multiple characteristics thereof, such as in the form of a two or three dimensional model used in computer games, social network applications, or other on-line communities. A typical avatar may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

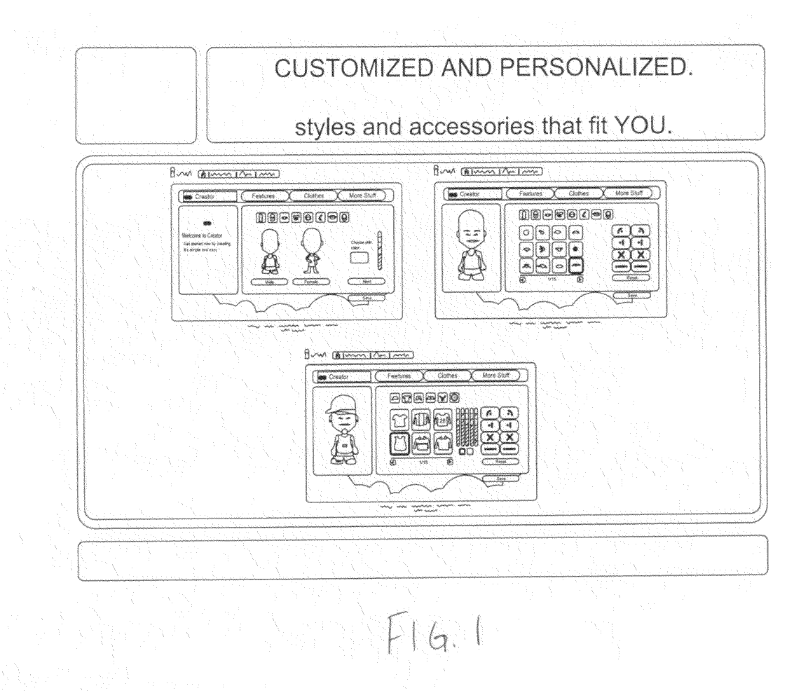

The present invention includes a fully portable, widgetized avatar having associated therewith multiple items of social information that are generally requested for association with at least two different computing communities or transactions. Widgetization of the avatar of the present invention necessarily allows for portability of the avatar of the present invention. For example, creation of a typical avatar in accordance with the present invention may include the association of physical, such as facial and hair, features with the subject avatar, as well as the aforementioned user name, as shown in FIG. 1. As may be seen in FIG. 1, an avatar creator may be used to create an avatar in a likeness of a user, such as a computer user's representation of him or herself, such as based on a single or multiple characteristics thereof. For example, user may select either a male or female avatar base. The user may select a skin tone of the avatar, such as to represent the user's skin tone. The creator of FIG. 1 may also be used to set a head profile and/or shape, an eye configuration and/or eye type, eyebrows, mouth, nose, ears and the like. Additionally, hair may be added to the avatar and the color, hair type, and general appearance of the hair may be configured. The avatar may also be outfitted in a clothing ensemble, and other type of accessories and/or clothing and the like will be discussed below. By way of non-limiting example headwear, shirts, pants, shorts, jewelry and other accessories, shoes and belts may be added to the created avatar as illustration in FIG. 1.

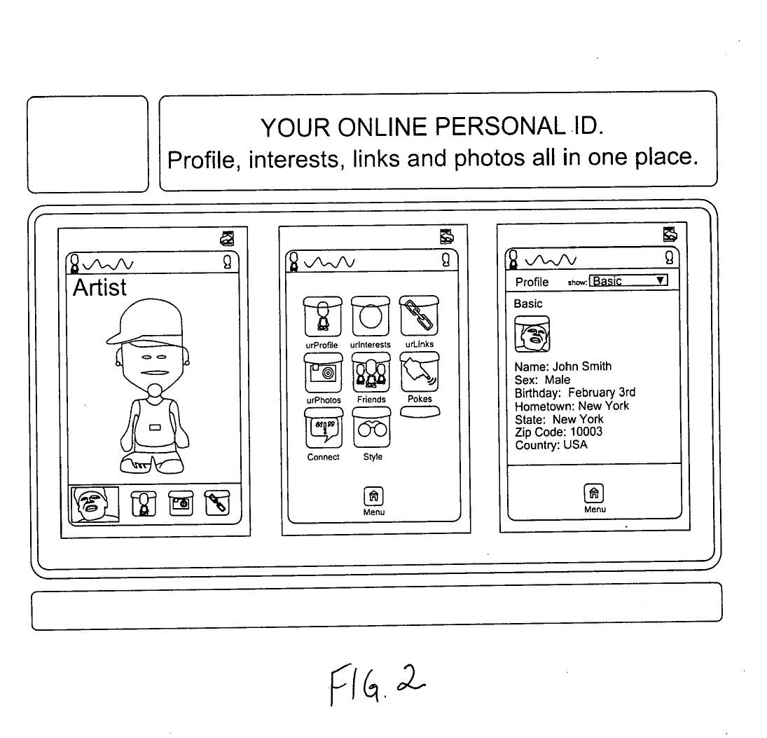

Further, a myriad of additional information may be associated with the avatar, wherein such information may be for use in computing communities or transactions. This information may be organized into multiple levels of detail, and/or multiple levels of accessibility to third parties in a computing community or transaction, for example. Such levels of a accessibility may be selected by the creator of the widgetized avatar based on characteristics of the third party endeavoring to access the subject avatar. For example, a user may have basic information, which may be selectable for viewing by all registered users of a particular community, as shown in FIG. 2.

In an exemplary embodiment, a user may have likes or dislikes, such as musical or motion picture tastes, job or educational status, age, location, income, marital status, and other computed communities with which that user is associated, associated with his or her avatar. The present invention provides a physical manifestation of all of this information, such as in a “trading card” format. For example, FIG. 2 illustrates an avatar wherein the front of the virtual trading card includes an avatar having particular physical features, clothing, accessories, activities, and the like, along with an associated user name. Additionally, on the front of the virtual trading card may be found commonly used links, such as the most commonly used among those links accessible through other aspects of the avatar or virtual trading card. This may include links to photos, avatar accessories, avatar features, movies, and the like, as shown.

For example, links on front of the virtual trading card may be populated by counting the number of times that a link is accessed by a user, and placing the top four, for example, on the front of the virtual trading card. Other mechanisms to populate the front of the trading card may also be used, such as allowing an advertiser to populate a spot, the user to populate a spot, the site from which the avatar was created to populate a spot, the fourth spot to be rotated by popularity for a given day, for example. These techniques may be combined to populate the front of the virtual trading card. While four spots have been discussed herein, any number of locations of the front of the card may be used, including any number of locations at the bottom, top and sides, for example.

When an interaction, such as selection of a drop-down menu, selection of a link, a double click, or the like is undertaken to “flip” a trading card to the back, a myriad of additional information may be displayed regarding the user related to the widgetized avatar, such as age, interests, likes and dislikes, employment status, and the like. The back of the virtual trading card may include links to a profile, interests, links, photos, friends, pokes, connections and style, by way of non-limiting example only. Each such link may provide information associated therewith. As shown in FIG. 2, a interaction, such as a click, for example, of the profile link may provide profile information for the user of the avatar, including but not limited to, name, sex, birthday, hometown and/or, address. More advanced profiles may also be initiated by dropdown menu, and may include credit card information, preferred websites, products that have been viewed or purchased, and other similar information.

Needless to say, because the virtual manifestation of the physical trading card is embodied in the computing code that provides for the virtual manifestation, such computing code may be provided in a normalized format that it is easily adopted into multiple computing communities, and/or may be adopted as non-static content onto multiple different web pages. As such, the subject avatar may be incorporated into multiple social communities, fantasy sports communities, blogs, and the like. In fact, tools to create such widgetized avatars may be accessible from, or provided within, such social communities, blogs, and the like. Further, avatars of particular interest to the general public, such as trading card avatars of musical artists or other famous persons, may be downloaded or referenced by fans of such famous persons. Such avatars may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

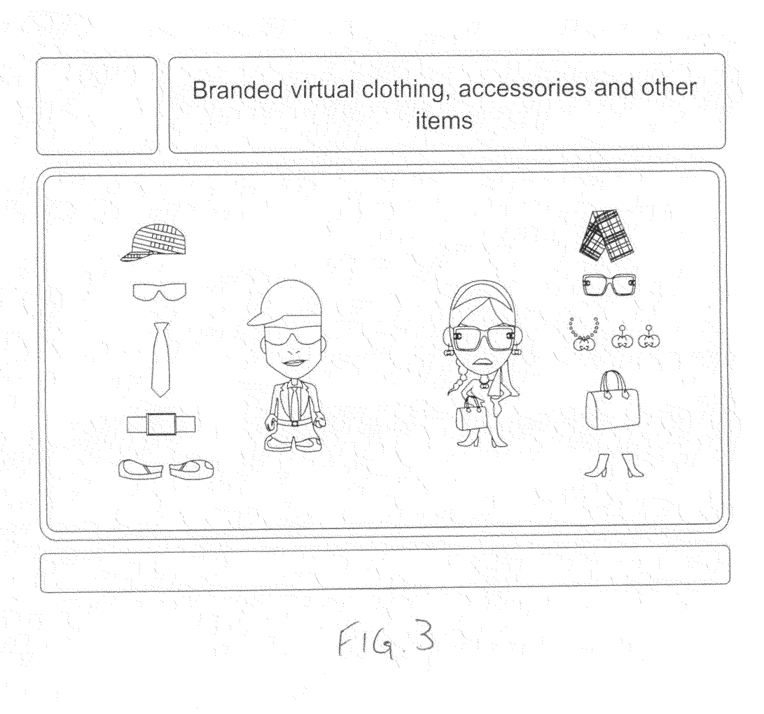

As referenced hereinabove, a typical avatar may have associated therewith certain physical features, clothing, accessories or activities. As such, the present invention is and includes a tool whereby such physical features, clothing, accessories, and activities may be taken from the real world and “virtualized”, for use with a subject avatar, as shown in FIG. 3. For example, famous clothing lines, such as Vera Wang clothing, or famous shoe lines, such as Nike sneakers, or famous accessories, such as Kate Spade purses, or well known activities, such as playing for the Philadelphia Phillies, may be virtualized for use with an avatar. As such, virtualized items may be made available for sale for use with an avatar just as the corresponding real items are generally for sale for use with the real world user correspondent to the avatar. As may be seen in FIG. 3, an avatar may be outfitted with a hat, sunglasses, tie, belt and shoes to create the fashioned avatar. Similarly, another avatar may be outfitted with a headscarf, necklace, earrings, purse and boots to create a fashioned avatar. Such outfitted avatars are discussed herein by way of non-limiting example only, and thus any real world configuration of attire may be included in a fashioned avatar.

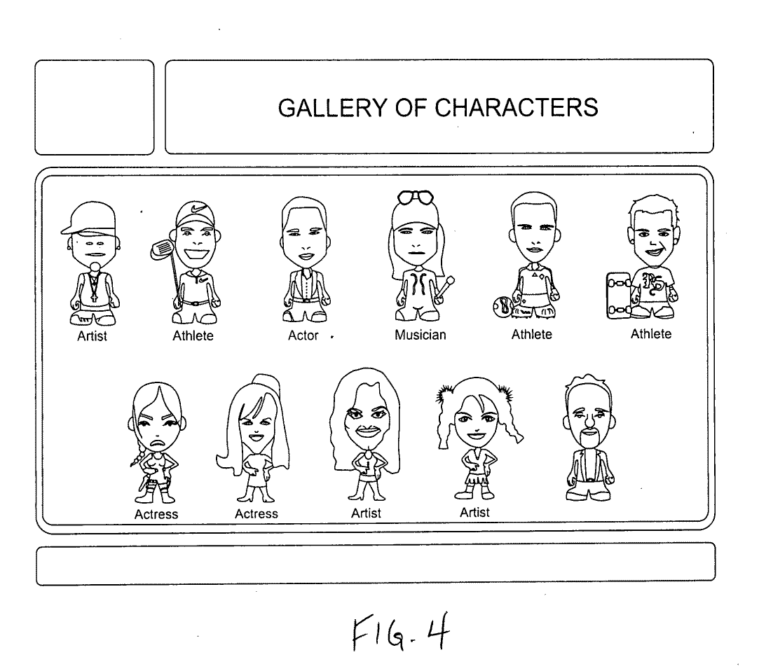

Likewise, celebrity avatars may be presented as “model” widgetized avatars, and the user may be enabled to purchase those items worn by the celebrity's avatar, and/or that are endorsed by that celebrity, as shown in FIG. 4. As may be seen in FIG. 4, a gallery of characters may be provided. The gallery may include artists, athletes, actors, musicians, actresses, and may include individualized characters, such as colleagues in a work environment, for example. These characters may include likenesses of the respective public figures and may also include accessories to further identify the public figure.

Thereby, for example, during creation of a discreet widgetized avatar and/or a widgetized avatar to be associated with the aforementioned avatar trading card, the user creating the avatar may have available a selectable library of options for association with the subject avatar, such as a searchable library of options searchable by key word, or a hierarchal library of options presented by topic. For example, under “fashion”, a user may be presented with available virtual clothing lines for the avatar by piece of clothing. For example, under “shirts”, the user may be presented with options such as Jones New York, Tommy Hilfiger, Fubu, Major League Baseball, National Football League, and the like. The user may then select one of the presented fashion topics for shirts, and then may be presented with the entire line of “real world” shirts associated with that fashion line, but, of course in a virtualized format. Thus, for example, upon selection of Major League Baseball, the user may be presented with a series of major league baseball team jerseys for association with that user's avatar. Needless to say, the user may then select the baseball jersey of that user's favorite team, and may in fact pay for the use of that virtual jersey just as the user might pay for the purchase of a real world jersey of that user's favorite baseball team. Similarly, fashion lines of pants, dresses, suits, shoes, and the like may be made available for use with avatars, and may in fact be made available for purchase by users for use with avatars. Likewise, accessories or activities that would require purchase in the real world by the user may additionally allow for purchase of such accessories or activities in the virtual world for use with the user's widgetized avatar.

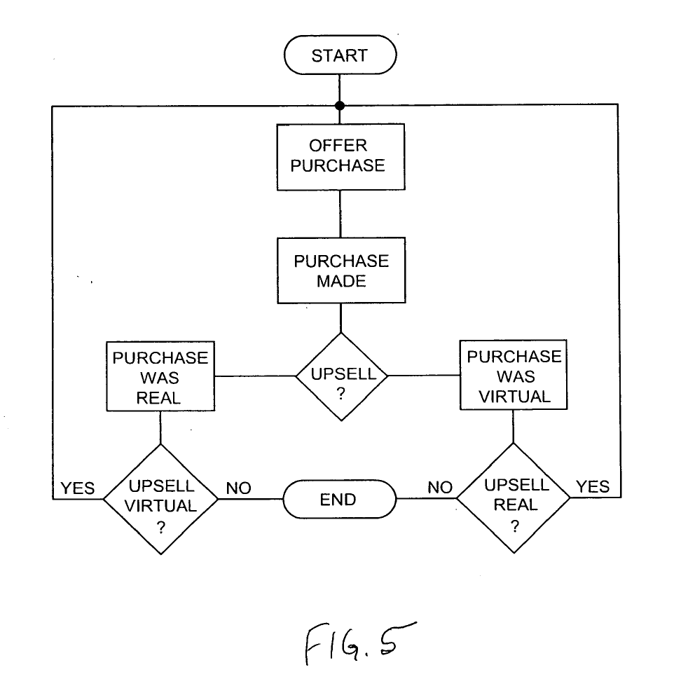

Additionally, the present invention may provide an upsell engine as illustrated in FIG. 5. The upsell engine may operate, upon purchase of a virtual item for association with the user's avatar, may present the user with an opportunity to purchase the same or similar article in the real world for real world use by the actual user based on that user's known preference for that article as evidenced by the purchase of the virtual article for use with the user's avatar. The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected. Needless to say, the present invention may also be used to upsell in the inverse situation—that is, the situation in which the user purchases a real world article from a particular web site, or surfs a particular web site for real world goods and/or services, may cause the user to be presented with advertising for the purchase of the same or similar virtual articles, or associated or related virtual articles, or to be presented with a direct opportunity to purchase the same, similar, or related virtual articles at the point of purchase of the particular real world article.

Similarly, games, rewards, or the like may be made available to, or via, the aforementioned avatars. For example, when certain objectives are achieved, such as in a gaming community, or based on criteria set forth by a parent with regard to homework, or based on a tracked number of interactions with others in a social circle within a computing community (such interactions need not be online, and need only be capable of being tracked), certain actions or gifts may be made available to or for use with a subject widgetized avatar. For example, three members of a social community may decide to form an avatar rock band, whereby, the more those three members communicate via email, instant message, SMS text, or the like, over a week, the better each member's avatar will play in a weekend “jam session.” Likewise, if an avatar corresponds to a person who makes a certain number of music purchases in a week, or a month, or in any predetermined time frame, the correspondent avatar may be enabled to dance with a certain popular musical artist, or dance as a certain popular musical artist in front of a concert crowd, for example. Other examples include, without limitation, allowing an avatar to play a sport, such as soccer, drive a car, such as a Ferrari, or accumulate points toward advancement in a game, or towards making purchases online.

Further, the present invention may allow for association of particular levels of expertise with particular areas of interest as related to the avatar trading card. As such, the user associated with the subject avatar may take a rating of that user's expertise in certain areas from computing community to computing community. Thus, searches may be made available in one or more computing communities for persons having desired levels of expertise in certain areas. The user may thus accumulate expertise points in multiple computing communities at the same time, wherein such points may be associated with that user's transferable widgetized avatar, whereby a user's expertise may rise based on accumulated expertise points. Additionally and alternatively, a user's expertise in a certain area may increase based on feedback from other users in one or more computing communities in relation to the subject users expertise in a particular area, or a user's expertise may increase based on an assignment of expertise levels by one or more of the computing communities, or a user's expertise level may rise based on advice offered, amount of advice offered, or purchase of expertise or advice from that user in or more on-line computing communities. Thus, a search by a party in need, such as a key word search, for an expert in a particular area may return not a user advertising to be an expert in a particular area, but instead may return a user adjudged to be an expert in a particular area by parties other than that user him or himself. Of course, in accordance with the present invention, such expertise levels may be associated with the avatar or avatar trading card, and as such may then subsequently be transferred to other computing communities.

Thus, the avatar of the present invention enables a user to create a portable, fully virtual, “person” for association with that user and carrying the characteristics of that user, including a personal profile and identification card that can be used in combination with any web page, web top or desk top and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

Thus, the avatar of the present invention may include one or more of the user profile, physicality of avatar, user personal characteristics, user interests, user links, user photos, videos, or audio, user friends, user sayings, jokes, or the like, user notes, connections or message postings, and user clothing, accessories, activities and general style. As used herein, the computing communities and transactions to which the avatar of the present invention may be transferred include all computing communities, including telecommunications communities such as those accessible from cellular telephones, televisions, and the like. As such, those skilled in the art will appreciate the all aspects of the avatar of the present invention, including creation and use, may be employed in any environment, including any mobile computing environment.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. An avatar, comprising:
computing code that provides for addition of the avatar as non-static content to at least two unique at least partially static web pages; and,
secondary computing code resident within said computing code, wherein said secondary computing code provides for association with at least one other portion of said computing code of:
ones selected from a plurality of physical characteristics;
a plurality of personal information; and
a plurality of actions.

2. The avatar of claim 1, wherein said ones selected from a plurality of physical characteristics comprise gender.

3. The avatar of claim 1, wherein said ones selected from a plurality of physical characteristics comprise skin color.

4. The avatar of claim 1, wherein said ones selected from a plurality of physical characteristics comprise facial appearance.

5. The avatar of claim 1, wherein said ones selected from a plurality of physical characteristics comprise a clothing ensemble.

6. The avatar of claim 1, wherein said plurality of personal information comprises a user's name.

7. The avatar of claim 1, wherein said plurality of personal information comprises a user's screen name.

8. The avatar of claim 1, wherein said plurality of personal information comprises a handle.

9. The avatar of claim 1, wherein said plurality of personal information comprises text of interest.

10. The avatar of claim 1, wherein said plurality of actions comprises rock band actions.

11. The avatar of claim 1, wherein said plurality of actions comprises dancing.

12. The avatar of claim 1, wherein said plurality of actions comprises athletics.

13. The avatar of claim 1, wherein said plurality of actions comprises playing a sport.

14. The avatar of claim 1, wherein said plurality of actions comprises driving a car.

15. An avatar trading card, said card comprising:
a front of the avatar trading card including an avatar,
a back of the avatar trading card including a selectable display for display of categorized information, wherein at least a portion of the categorized information is associated with one or more subjects of the avatar; and,
a toggle that provides for a toggle between said back and said front,
wherein the selectable display provides selectability of categorized information.

16. The avatar trading card of claim 15, wherein said categorized information includes at least one of user profile, interests, links, photos, friends and style.

17. The avatar trading card of claim 16, wherein said one user profile comprises personal information.

18. The avatar trading card of claim 16, wherein said interests comprises personal likes of a user.

19. The avatar trading card of claim 16, wherein said links comprises online connections.

20. The avatar trading card of claim 15, wherein said front of the card further comprises at least one link to secondary information.

21. The avatar trading card of claim 20, wherein said at least one link to secondary information comprises at least one of user profile, interests, links, photos, friends and style.

22. The avatar trading card of claim 15, wherein said back of the card further comprises user identifying characteristics

23. A method of configuring an online persona, said method comprising:
creating an avatar representative of a likeness of a computer user; and,
configuring said created avatar by:
modifying a first set of visible attributes, and accepting a first set of identifying information that is linked to said first set of visible attributes;
modifying a second set of visible attributes, and accepting a second set of identifying information that is linked to said second set of visible attributes,
wherein the accepting of said first set of identifying information increases a number of available ones of the first set of visible attributes, and
wherein accepting said second set of identifying information increases a number of available ones of the second set of visible attributes.
